(19) United States
(12) Patent Application Publication
(10) Pub. No.: US 2015/0273990 A1
(43) Pub. Date: Oct. 1, 2015

(54) GLASS RUN FOR AUTOMOBILE

(71) Applicant: TOYODA GOSEI CO., LTD., Kiyosu-shi (JP)

(72) Inventors: Kentaro ADACHI, Kiyosu-shi (JP); Mitsunobu TERAMOTO, Kiyosu-shi (JP)

(21) Appl. No.: 14/636,235

(22) Filed: Mar. 3, 2015

(30) Foreign Application Priority Data
Mar. 26, 2014 (JP) 2014-063360

(51) Int. Cl. B60J 5/04; B60J 1/17; B60J 10/00

(52) U.S. Cl. CPC B60J 5/0402; B60J 10/0017; B60J 10/0054; B60J 1/17

(57) ABSTRACT

A glass run capable of being readily assembled on a corner of a door frame of an automobile door with excellent sealing properties. Straight parts of the glass run include an upper side part, a front vertical side part and a rear vertical side part. In a corner part of the glass run, an outer side wall, an inner side wall, a bottom wall of a glass run section, an outer seal lip and an inner seal lip are connected to corresponding parts of the upper side part and the vertical side part by molding into an inclined or curved configuration. An exterior surface of the bottom wall of the glass run section is arranged such that an intersection point of an extension line of an end line of a front vertical side or a rear vertical side of the door frame, which is on the side of a door glass, and a trim section of the upper side part of the glass run is located on an outer peripheral side of the exterior surface of the bottom wall of the glass run section.

### CROSS-REFERENCE TO RELATED APPLICATION

This application is related to and claims priority from Japanese patent Application No. 2014-063360 incorporated herein by reference.

### BACKGROUND OF THE INVENTION

1. Field of the Invention

The present invention relates to a glass run adapted to be attached to an inner periphery of a door frame of an automobile door for guiding a door glass as it is raised and lowered.

2. Description of Related Art

As shown in FIG. 1, a glass run 10 is attached to an inner periphery of a door frame 12 of an automobile door 14 for guiding a door glass 16 as it is raised and lowered. A conventional attaching structure of the glass run 10 is shown in FIG. 2. FIG. 2 is a cross-sectional view taken along line A-A in FIG. 1, which shows the attaching relationship of the glass run 10 and weather strips in the door frame 12 and a door opening portion 18.

As shown in FIG. 2, conventionally, the glass run 10 is fitted in a channel 20 of the door frame 12 to guide the door glass 16 that is assembled in a door glass opening provided on an interior side of the door frame, upwardly and downwardly, and seal a gap between the door glass 16 and the door frame 12. And, as shown in FIG. 1, in the glass run 10, straight parts 22 formed by extrusion for attachment to an upper side, a front vertical side and a rear vertical side of the door frame 12, are connected to each other with a corner part 24 formed by molding in conformity with the configuration of the door frame 12.

On the other hand, as shown in FIG. 2, a seal between the automobile door 14 and an automobile body is effected with a door weather strip 26 attached to an outer periphery of the door frame 12, and/or an opening trim weather strip 28 attached to a flange provided in the door opening portion 18 of the automobile body. When the automobile door 14 is closed, a tubular seal portion of the opening trim weather strip 28 contacts and seals an interior side surface of a protrusion of an inner panel 30 of the door frame 12.

As shown in FIG. 2, the glass run 10 includes an outer side wall 32, an inner side wall 34 and a bottom wall 36, and has a generally U-shaped cross-section. An outer seal lip 38 is provided to extend from an open end of the outer side wall 32 towards an interior of the glass run 10. And an inner seal lip 40 is provided to extend from an open end of the inner side wall 34 towards the interior of the glass run 10. An outer cover lip 42 extends from the open end of the outer side wall 32 toward the bottom wall 36 along an exterior surface of the outer side wall 32, and an inner cover lip 43 extends from the open end of the inner side wall 34 toward the bottom wall 36 along an exterior surface of the inner side wall 34. The outer cover lip 42 and the inner cover lip 43 may be formed short according to the configuration of the door frame 12.

And, as shown in FIG. 1, in a corner 44 of the door frame 12, the upper side of the door frame 12 abuts the rear vertical side thereof. And they are joined to each other, and an upper side and a rear vertical side of the channel 20 are joined to each other, similarly. As a result, the corner 44 of the door frame 12 is formed into an acute angle, and the corner part 24 of the glass run 10 is formed into an acute angle by molding in conformity with the configuration of the channel 20.

As shown in FIG. 3, where a flange end of the door frame 12 is covered with a glass run 46, in a corner part 48 connecting an upper side part 50 to a rear vertical side part 52, the upper side of the door frame 12 is covered with a bottom wall 54 of a trim section 56 of the glass run 46 such that exterior surfaces of the bottom wall 54 and an outer side wall 58 of a glass run section 60 are visible from an automobile exterior side. In the corner part 48, the bottom wall 54 and the outer side wall 58 of the glass run 46 extend continuously from the upper side part 50 towards an end of the corner part 48 (see Japanese patent application laid-open No. 2002-46476, for example).

In addition, in the corner part 48 connecting the upper side part 50 to the rear vertical side part 52, the outer side wall 58, an outer seal lip 62, an inner side wall 64, an inner seal lip 66 and a bottom wall 68, each extending from the rear vertical side part 52, are respectively connected to those of the upper side part 50.

As shown in FIG. 3, in a joint 70, the outer seal lip 62 of the rear vertical side part 52 is linearly connected to a root of the outer seal lip 62 in an extension portion of the upper side part 50 such that the bottom wall 54 and the outer side wall 58 of the upper side part 50 of the glass run 46 define a molding part of which design continues laterally.

In this case, the trim section 56 inclusive of the bottom wall 54 is formed of a hard member for attaching the trim section 56 to the flange of the door frame 12. When a corner part of the glass run 46 is attached to the corner of the door frame 12, the trim section 56 is difficult to be deformed, and since the outer seal lip 62 of the rear vertical side part 52 is linearly connected, the fitting workability of the glass run 46 in the channel 20 of the vertical side of the door frame 12 has not been preferable.

In order to overcome the above-described problem, as shown in FIG. 4, in a corner part 72 of a glass run 74, a cover-like seal lip 76 is provided on an end of an outer side wall 78 of a vertical side part 80 so as to be close to an outer side seal lip 82 of an upper side part 84 for separating an outer side seal lip 86 of the vertical side part 80 from the outer side seal lip 82 of the upper side part 84 (see Japanese patent application laid-open No. 2001-322437, for example).

In this case, however, a seal line connecting the outer side seal lip 86 of the vertical side part 80 and the outer side seal lip 82 of the upper side part 84 is broken in the corner part 72 to cause degradation in sealing properties therearound.

### SUMMARY OF THE INVENTION

It is an object of the present invention to provide a glass run of which a corner part adapted to connect an upper side part and a vertical side part of the glass run is readily attached to a corner of a door frame of an automobile door with excellent sealing properties.

In order to achieve the above-described object, according to a first aspect of the present invention, in a glass run for an automobile, which is adapted to be attached to an inner periphery of a door frame of a door of an automobile for guiding a door glass as it is raised and lowered, including straight parts formed by extrusion, and corner parts attached to corners of the door frame and formed by molding,

the straight parts of the glass run include an upper side part for attachment to an upper side of the door frame, a front vertical side part for attachment to a front vertical side of the door frame, and a rear vertical side part for attachment to a rear vertical side of the door frame,

the upper side part of the glass run integrally includes a glass run section and a trim section composed of a hard material, the glass run section has an outer side wall, an inner side wall and a bottom wall defining a generally U-shaped cross-section, and an outer seal lip and an inner seal lip are provided so as to respectively extend from ends of the outer side wall and the inner side wall obliquely inwardly to seal an exterior surface and an interior surface of an end edge of the door glass,

the front vertical side part or the rear vertical side part of the glass run has an outer side wall, an inner side wall and a bottom wall of a glass run section, which define a generally U-shaped cross-section, an outer seal lip is provided to extend from an end of the outer side wall obliquely inwardly, and an inner seal lip is provided to extend from an end of the inner side wall obliquely inwardly, and

in a corner part connecting the upper side part to the front vertical side part or the rear vertical side part, the outer side wall, the inner side wall, the bottom wall of the glass run section, the outer seal lip and the inner seal lip are connected to corresponding parts of the upper side part and the vertical side part by molding into one of an inclined or a curved configuration, and an exterior surface of the bottom wall of the glass run section is arranged such that an intersection point of an extension line of an end line of the front vertical side or the rear vertical side of the door frame, which is on the side of the door glass, and the trim section of the upper side part of the glass run is located on an outer peripheral side of the exterior surface of the bottom wall of the glass run section of the upper side part of the glass run.

With the arrangement of the first aspect of the present invention, the straight parts of the glass run include an upper side part for attachment to an upper side of the door frame, a front vertical side part for attachment to a front vertical side of the door frame, and a rear vertical side part for attachment to a rear vertical side of the door frame. Therefore, the straight parts of the glass run can provide suitable cross-sections.

The upper side part of the glass run integrally includes a glass run section and a trim section composed of a hard material so that the trim section holds a flange along a tip of the door frame, whereby a bottom wall of the trim section and the outer side wall can define an integrally continued molding surface, which is preferable in design. Since the hard trim section is attached to the flange of the door frame, the glass run section can be strongly held with the door frame.

The glass run section has an outer side wall, an inner side wall and a bottom wall defining a generally U-shaped cross-section, and an outer seal lip and an inner seal lip are provided so as to respectively extend from ends of the outer side wall and the inner side wall obliquely inwardly to seal an exterior surface and an interior surface of an end edge of the door glass.

Therefore, when the automobile door is closed, an upper end edge of the door glass can be accommodated in an interior of the glass run section defined with the outer side wall, the inner side wall and the bottom wall. The outer seal lip and the inner seal lip are arranged to seal the exterior surface and the interior surface of the door glass so that when the door glass is raised, the seal lips contact the door glass, thereby providing a seal between the upper side of the door frame and the door glass with the outer seal lip and the inner seal lip.

The front vertical side part or the rear vertical side part of the glass run has an outer side wall, an inner side wall and a bottom wall of a glass run section, which define a generally U-shaped cross-section, an outer seal lip is provided to extend from an end of the outer side wall obliquely inwardly, and an inner seal lip is provided to extend from an end of the inner side wall obliquely inwardly.

Therefore, when the door glass is raised and lowered, a side end edge of the door glass can be accommodated in an interior of the vertical side part of the glass run having the outer side wall, the inner side wall and the bottom wall of the glass run section, whereby the door glass can be securely held. Since the outer seal lip and the inner seal lip are arranged to seal the exterior surface and the interior surface of the side end edge of the door glass, the seal lips contact the door glass according to the raising and lowering of the door glass, whereby the outer seal lips and the inner seal lip can provide a seal between the door frame and the door glass.

In the corner part connecting the upper side part to the front vertical side part or the rear vertical side part, the outer side wall, the inner side wall, the bottom wall of the glass run section, the outer seal lip and the inner seal lip are connected to corresponding parts of the upper side part and the vertical side part by molding into one of an inclined or a curved configuration. Therefore, in the corner part of the glass run, the side walls and the seal lips are formed continuously to ensure the sealing properties of the corner part.

The exterior surface of the bottom wall of the glass run section is arranged such that an intersection point of an extension line of an end line of the front vertical side or the rear vertical side of the door frame, which is on the side of the door glass, and the trim section of the upper side part of the glass run is located on an outer peripheral side of the exterior surface of the bottom wall of the glass run section of the upper side part of the glass run. Therefore, when the glass run is attached to the corner of the door frame, and an upper side of the corner part of the glass run is attached to the upper side of the door frame, the corner part of the glass run is not restrained with the door frame in an area close to the upper side of the corner part of the glass run, whereby the deformation amount of the corner part of the glass run, which is caused by the assembling of the corner part, is small so that a vertical side of the corner part of the glass run can be readily assembled on the door frame.

According to a second aspect of the present invention, the exterior surface of the bottom wall of the glass run section of the corner part is formed into an oblique and straight configuration.

With the second aspect of the present invention, the exterior surface of the bottom wall of the glass run section of the corner part is formed into an oblique and straight configuration so that it is unnecessary to fit the obliquely and straight area of the corner part of the glass run to the corner of the door frame, thereby facilitating the assembling of the glass run on the door frame. The gap between the bottom wall of the glass run section and the corner of the door frame can be filled with a corner piece.

According to a third aspect of the present invention, the exterior surface of the bottom wall of the glass run section of the corner part is attached so as to be separated from a bottom of a channel provided in the corner of the door frame.

With the third aspect of the present invention, the exterior surface of the bottom wall of the glass run section of the corner part is attached so as to be separated from a bottom of a channel provided in the corner of the door frame so that it is unnecessary to fit the bottom wall of the glass run section of the corner part of the glass run in the corner of the door frame, thereby facilitating the assembling of the glass run.

In the corner part of the glass run, the outer side wall, the inner side wall, the bottom wall of the glass run section, the outer seal lip and the inner seal lip are connected to corresponding parts of the upper side part and the vertical side part by molding into one of an inclined or a curved configuration. Therefore, in the corner part of the glass run, the side walls and the seal lips are formed continuously to ensure the sealing properties of the corner part.

The exterior surface of the bottom wall of the glass run section is arranged such that an intersection point of an extension line of an end line of the front vertical side or the rear vertical side of the door frame, which is on the side of the door glass, and the trim section of the upper side part of the glass run is located on an outer peripheral side of the exterior surface of the bottom wall of the glass run section of the upper side part of the glass run. Therefore, when the glass run is attached to the corner of the door frame, the corner part of the glass run is not restrained with the door frame so that the vertical side of the corner part of the glass run can be readily assembled on the door frame.

Other objects, features, and characteristics of the present invention will become apparent upon the consideration of the following description and the appended claims with reference to the accompanying drawings, all of which form a part of this specification.

### BRIEF DESCRIPTION OF THE DRAWINGS

FIG. 1 is a side view of a motor vehicle;

FIG. 2 is a diagram showing the attaching relationship of a conventional glass run to a door frame;

FIG. 3 is a front view of a corner part of another conventional glass run;

FIG. 4 is a partially cut away perspective view of a corner part of still another conventional glass run;

FIG. 5 is a cross-sectional view of an upper side part in one embodiment of a glass run in accordance with the present invention;

FIG. 6 is a cross-sectional view of a rear vertical side part in one embodiment of a glass run in accordance with the present invention;

FIG. 7 is a front view of a corner part in one embodiment of a glass run in accordance with the present invention, to which a partially cut away part of a trim section of an upper side part thereof is attached;

FIG. 8 is a front view of a corner part in one embodiment of a glass run in accordance with the present invention;

FIG. 9 is a front view of a corner part in one embodiment of a glass run in accordance with the present invention, in which a door glass is fitted;

FIG. 10 is a front view of a corner part in one embodiment of a glass run in accordance with the present invention, which is fitted in a vertical side of a door frame after fitting a door glass ;

FIG. 11 is a cross-sectional view of a corner part in one embodiment of a glass run in accordance with the present invention, taken along line A-A in FIG. 8; and

FIG. 12 is a cross-sectional view of a corner part in one embodiment of a glass run in accordance with the present invention, taken along line B-B in FIG. 8;

### DETAILED DESCRIPTION OF THE PREFERRED EMBODIMENTS

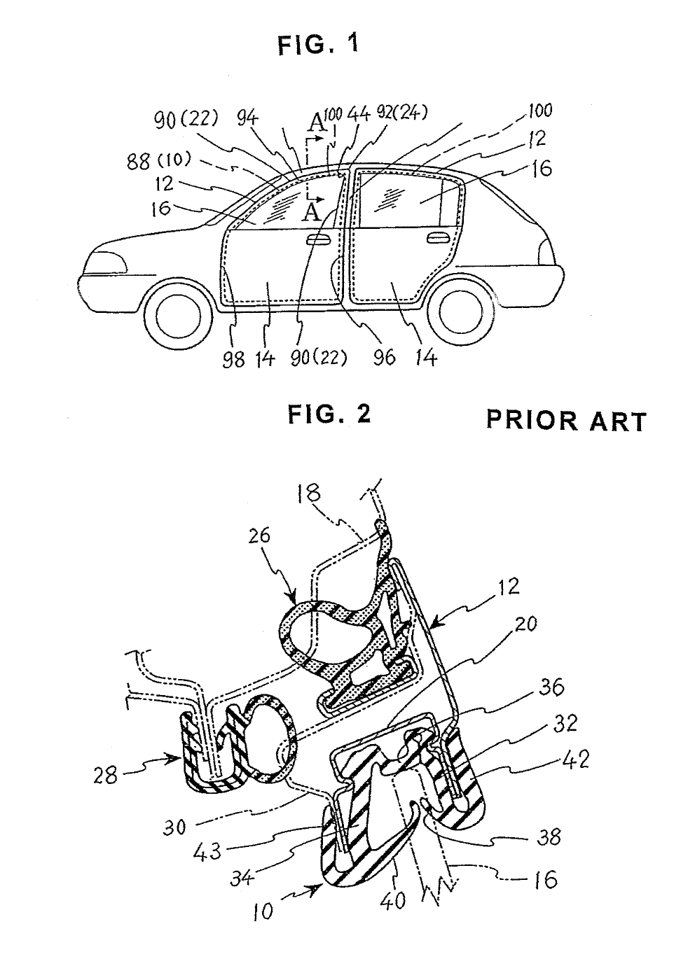

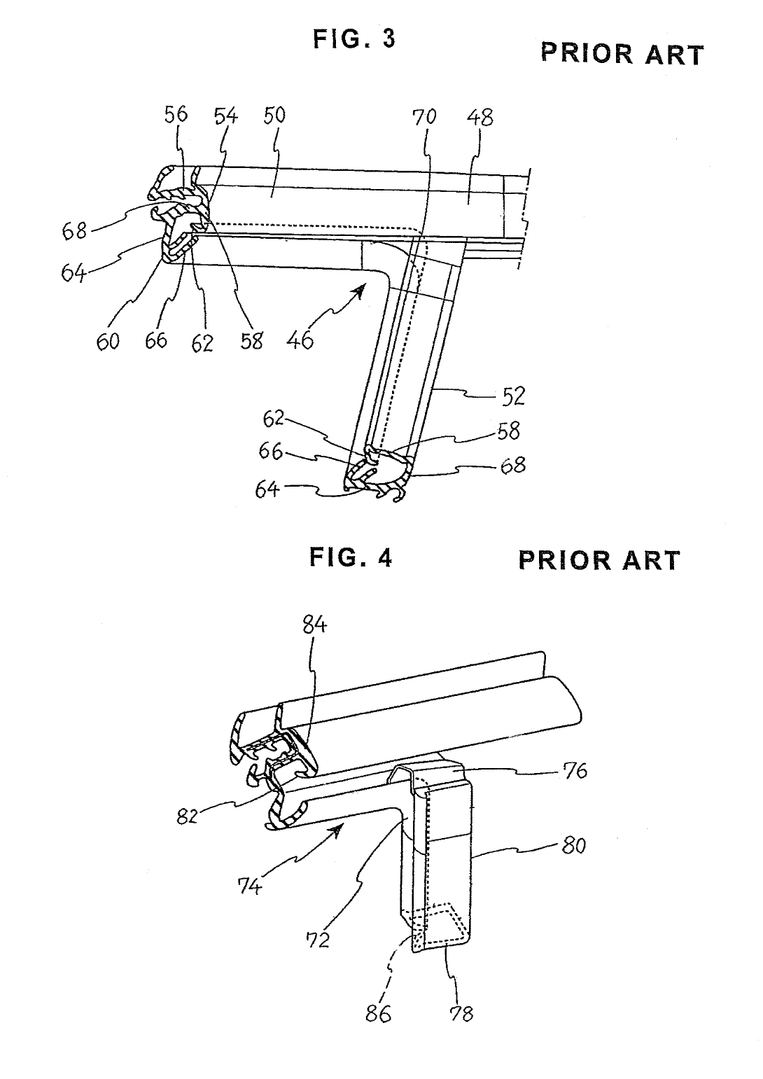

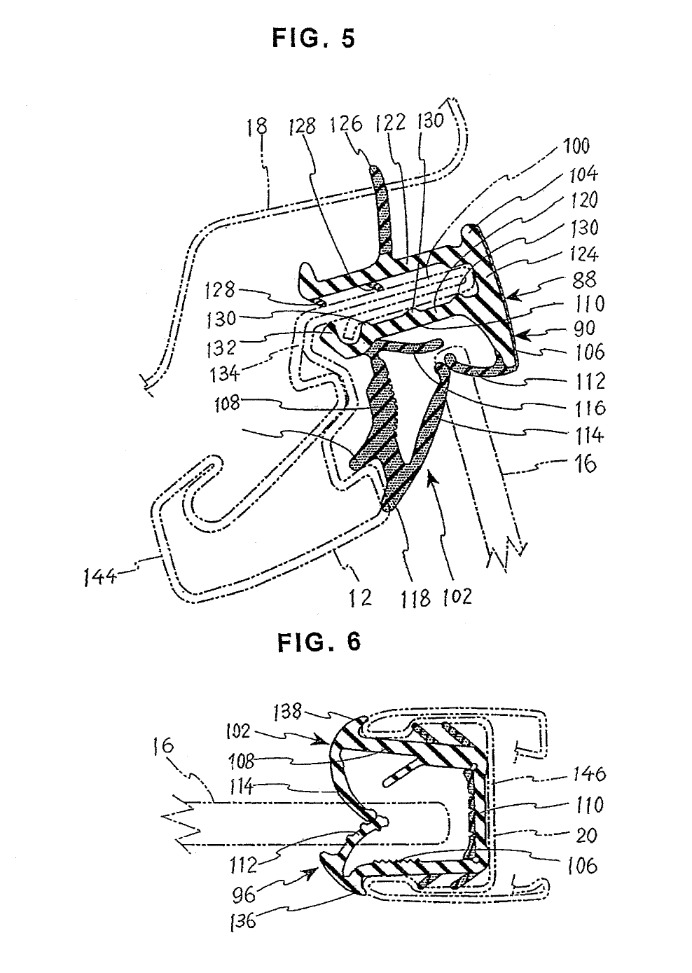

One embodiment of the present invention will be explained with reference to FIG. 1, and FIG. 5 through FIG. 12.

FIG. 1 is a side view of an automobile.

As shown in FIG. 1, a door frame 12 is provided in an upper part of an automobile door 14, and a door glass 16 is attached thereto so as to be raised and lowered therealong. The door glass 16 and a glass run 88 are provided in a door glass opening on an interior side of the door frame 12, and the glass run 88 guides the door glass 16 as it is raised and lowered, and provides a seal between the door glass 16 and the door frame 12.

The glass run 88 includes straight parts 90, each having an approximately linear shape and being formed by extrusion, and a corner part 92 formed by molding to connect the straight parts 90 to each other, and attached to the corner 44 of the door frame 12.

The straight parts 90 include an upper side part 94 for attachment to an upper side of the door frame 12, a rear vertical side part 96 for attachment to a rear vertical side of the door frame 12 and a front vertical side part 98 for attachment to a front vertical side of the door frame 12. On the front side of the automobile door 14, the upper side of the door frame 12 is formed obliquely downwardly towards a front end of an automobile so that the upper side part 94 makes an obtuse angle with the front vertical side part 98 of the glass run 88. The door frame 12 has a flange 100 along the upper side thereof for attaching the upper side part 94 of the glass run 88, and a channel having an approximately U-shaped cross-section for attaching the glass run 88 is provided in the vertical side of the door frame 12.

These straight parts 90 of the glass run 88 are connected in corners by molding in conformity with the configuration of the door frame 12 to define the corner part 92 for attachment to the corner 44 of the door frame 12.

The present invention will be explained with reference to a rear corner part 92 of a front door 14, but the present invention can be also applied to a front corner of a rear door.

As shown in FIG. 5, the upper side part 94 of the glass run 88 includes a glass run section 102 adapted to be attached along an inner periphery of the door frame 12, and a trim section 104 adapted to be attached to the flange 100 that is provided along a tip of the door frame 12.

The glass run section 102 has a main body with a generally U-shaped cross-section, which includes an outer side wall 106, an inner side wall 108 and a bottom wall 110. An outer seal lip 112 and an inner seal lip 114 respectively extend from ends of the outer side wall 106 and the inner side wall 108 obliquely in an interior space of the main body. Therefore, an end edge of the door glass 16 slides in the interior space of the main body of the glass run section 102, which includes the outer side wall 106, the inner side wall 108 and the bottom wall 110, thereby holding the door glass 16.

The inner side wall 108, the outer seal lip 112 and the inner seal lip 114 of the glass run section102 are composed of a soft material. It is preferable to use a thermoplastic olefin elastomer as the soft material.

The outer side wall 106 and the bottom wall 110 are composed of a hard material.

The outer side wall 106 is formed so as to have a thick root and gradually decrease its thickness to its tip end. In addition, the outer side wall 106 is formed to define a curved interior surface. As a result, the outer side wall 106 exhibits great rigidity so that if the door frame 12 greatly curves, deformations such as wrinkles, waving, etc. of the outer side wall 106 can be prevented. And if the door glass 16 is shifted outwardly, the outer side wall 106 can hold the end edge of the door glass 16 to prevent the door glass 16 from coming off the glass run section 102.

It is preferable to increase the width and the thickness of both the inner side wall 108 and the inner seal lip 114, as compared with those of the outer side wall 106 and the outer seal lip 112. In this case, when the door glass 16 is raised and inserted in the interior space of the glass run 88, the door glass 16 can be shifted outwardly to reduce level difference in the exterior surface of the door 14, thereby improving the appearance therearound, and restraining the generation of wind noises. In addition, the inner side wall 108 can be securely attached to an attaching surface of the door frame 12.

A bottom lip 116 can be formed on an interior side of the bottom wall 110 so as to project from a joint between the inner side wall 108 and the bottom wall 110. When the door glass 16 is raised, an upper edge of the door glass 16 contacts the bottom lip 116 to absorb shocks against the bottom wall 110.

The inner side wall 108, the outer seal lip 112 and the inner seal lip 114 along with an inner cover lip 118 are composed of a soft material. Therefore, the outer seal lip 112 and the inner seal lip 114 can seal the end edge of the door glass 16. In addition, where the door frame 12 is formed into a curved shape, the inner side wall 108 flexibly bends to facilitate the attachment of the glass run section 102 to the door frame 12.

Next, the trim section 104 will be explained. The trim section 104 has a generally U-shaped cross-section defined with a side wall 120 integrally formed with the bottom wall 110 of the glass run section 102, a side wall 122 for facing the door opening portion 18, and a bottom wall 124.

The flange 100 of the door frame 12 is inserted into an interior space of the trim section 104, and held therewith, whereby the glass run 88 is attached to the door frame 12. In the present embodiment, the bottom wall 110 of the glass run section 102 and the side wall 120 of the trim section 104 are integrally formed as a single member composed of the same material.

An outer seal lip 126 projects from an exterior surface of the side wall 122 of the trim section 104, which faces the door opening portion 18. As shown in FIG. 5, when the door 14 is closed, the outer seal lips 126 contacts the door opening portion 18 to provide a seal between the door opening portion 18 and the door frame 12.

Two inner seal lips 128 are formed on an interior surface of the side wall 122 of the trim section 104, and three holding ridges 130 are formed on an interior surface of the side wall 120 of the trim section 104. As shown in FIG. 5, when the flange 100 of the door frame 12 is inserted into the interior space of the trim section 104, one side surface of the flange 104 can be held with the inner seal lips 128, whereas the other side surface of the flange 104 can be held with the holding ridges 130. In addition, the trim section 104 can be stably attached to the flange 100 of the door frame 12.

An engaging lip 132 is formed along an end of the side wall 120 of the trim section 104 inwardly thereof. When the flange 100 of the door frame 12 is inserted into the interior space of the trim section 104, the engaging lip 132 engages with a hook 134 of the flange 100 so that when a side visor is bonded to the trim section 104, the trim section 104 hardly comes off the flange 100.

The side walls 120 and 122, the bottom wall 124, the engaging lip 132, and the holding ridges 130 of the trim section 104 are composed of a hard material, whereas the outer seal lip 126 and the inner seal lips 128 of the trim section 104 are composed of a soft material. The trim section 104 thus arranged is simultaneously formed by extrusion of the hard material and the soft material. As described above, the outer side wall 106 of the glass run section 102 is composed of a hard material so that the rigidity of a bonding area of the side visor can be increased.

With this arrangement, the main body of the trim section 104 can exhibit high rigidity so as to hold the flange 100 of the door frame 12, the outer seal lip 126 can flexibly contact and seal the door opening portion 18 in conformity with the configuration thereof, and the inner seal lips 128 can flexibly contact and seal the flange 100.

Since the engaging lip 132 of the trim section 104 is composed of a hard material, the trim section 104 can be strongly engaged with the flange 100.

Next, the cross-sectional shape of the rear vertical side part 96 will be explained with reference to FIG. 6. The front vertical side part 98 has the cross-sectional shape similar to that of the rear vertical side part 96. The rear vertical side part 96 has only a glass run section 102 for attachment to an inner periphery of the door frame 12, but does not have any trim section. The cross-sectional shape of the glass run section 102 is similar to that of the upper side part 94 of the glass run 88, and has a main body with a generally U-shaped cross-section, which includes an outer side wall 106, an inner side wall 108 and a bottom wall 110. An outer seal lip 112 and an inner seal lip 114 respectively extend from ends of the outer side wall 106 and the inner side wall 108 obliquely in an interior space of the main body. Therefore, an end edge of the door glass 16 slides in the interior space of the main body of the glass run section 102, which includes the outer side wall 106, the inner side wall 108 and the bottom wall 110, whereby the door glass 16 can be held with the glass run section 102.

An outer cover lip 136 and an inner cover lip 138 extend from tip ends of the outer side wall 106 and the inner side wall 108 outwardly of the main body having a generally U-shaped cross-section to attach the glass run section 102 in the channel 20 of the door frame 12.

The inner side wall 108, the outer seal lip 112, and the inner seal lip 114 of the glass run section 102 are composed of a soft material. It is preferable to use olefin thermoplastic elastomer as the soft material.

Next, the corner part 92 of the glass run 88 will be explained.

As shown in FIG. 1, in a rear corner 44 of the automobile door 14, an upper side 144 of the door frame 12 is formed approximately horizontally, whereas a rear vertical side 146 of the door frame 12 is formed approximately vertically. The upper side 144 and the rear vertical side 146 are joined to each other so as to abut each other. And, as shown in FIG. 1, the corner part 92 of the glass run 88 is attached to the rear corner 44 of the door frame 12.

As shown in FIG. 1, the corner part 92 of the glass run 88 connects the upper side part 94 for attachment to the upper side 144 of the door frame 12 to the rear vertical side part 96 for attachment to the rear vertical side 146 of the door frame 12, and is formed by molding in conformity with the configuration of the corner 44 of the door frame 12. The corner part 92 connects the upper side part 94 to the rear vertical side part 96 with heat generated while molding.

The corner part 92 between the upper side part 94 and the rear vertical side part 96 of the front door will be explained, but a corner part between the upper side part 94 and the front vertical side part 98 of the rear door has a similar construction.

The corner part 92 of the glass run 88 has a following configuration. An upper side of the corner part 92, which is adapted to be connected to the upper side part 94, has an approximately similar cross-sectional shape to that of the upper side part 94, and an outer side surface of the corner part 92, which is continuously defined with the outer side wall 106 and the bottom wall 124, is linearly extended to an end of the door frame 12 to serve as a molding. As a result, in the corner part 92, exterior surfaces of the outer side wall 106 and the bottom wall 124 of the trim section 104 are extended continuously with the upper side part 94 without any break, and consequently, laterally continuous design surfaces are obtained, which is favorable in design.

A vertical side of the corner part 92, which is adapted to be connected to the rear vertical side part 96, has an approximately similar cross-sectional shape to that of the rear vertical side part 96. And the outer side wall 106, the inner side wall 108, the bottom wall 110 of the glass run section, the outer seal lip 112 and the inner seal lip 114 of the upper side and the vertical side of the corner part 92 are respectively connected to corresponding parts thereof.

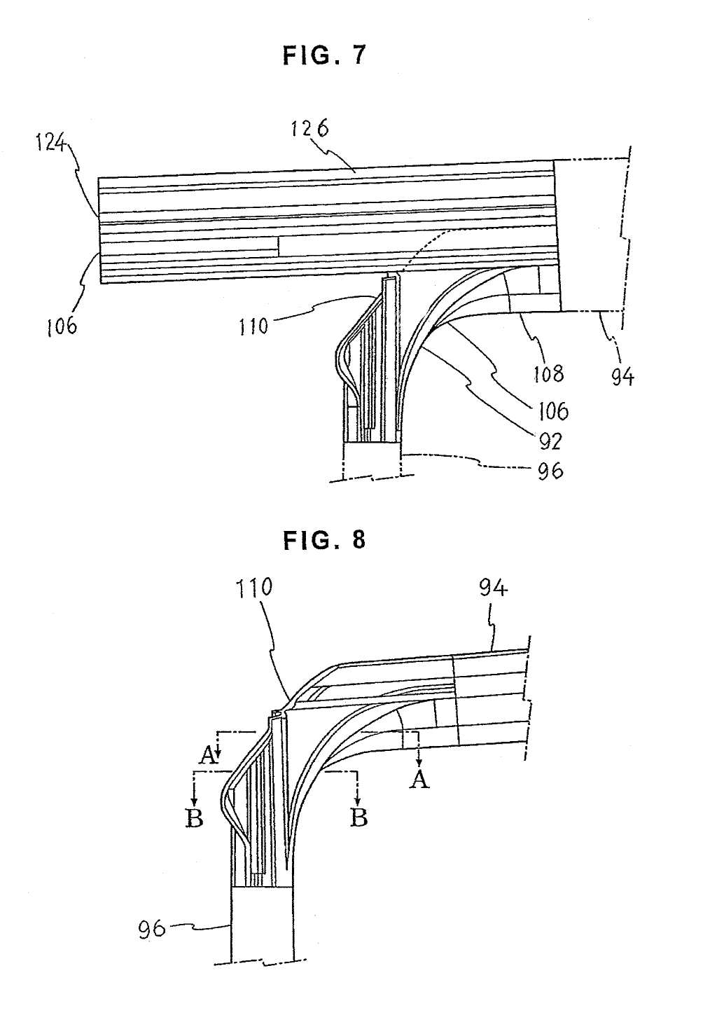

As shown in FIGS. 7 and 8, in order to connect the upper side part 94 of the glass run 88 to the rear vertical side 96 thereof, the corner part 92 is formed into an inclined or curved configuration. In the present embodiment, tip ends of the outer side wall 106 and the inner side wall 108 of the corner part 92 are respectively formed into a curved arcuate configuration, whereas an exterior surface of the bottom wall 110 of the glass run section 102 is formed into an inclined linear configuration.

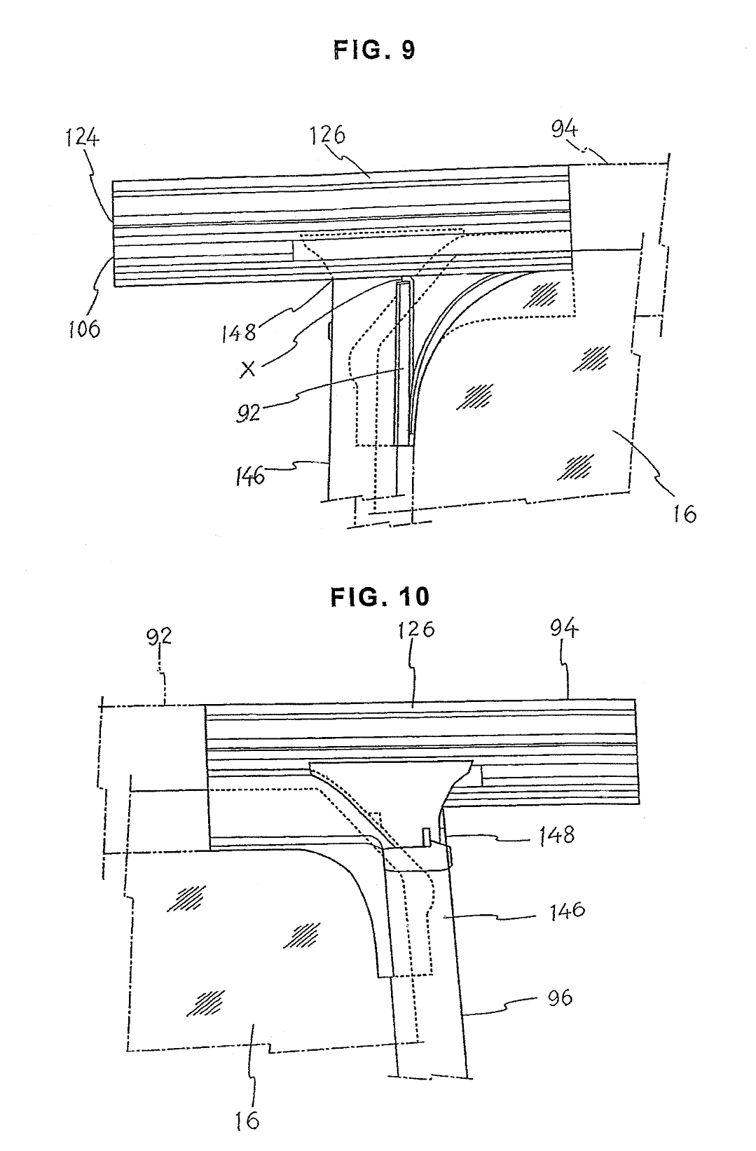

As shown in FIG. 9, the exterior surface of the bottom wall 110 of the glass run section 102 is arranged such that an intersection point X (X is designated in FIG. 9) of an extension line of an end line of the vertical side 146 of the door frame 92, which is on the side of the door glass 16, and the trim section of the upper side part 94 of the glass run 88 is located on an outer peripheral side of the exterior surface of the bottom wall 110 of the glass run section 102. When the glass run 88 is attached to the corner 44 of the door frame 12, the upper side of the corner part 92 of the glass run 88 is attached to the upper side 144 of the door frame 12. At this time, an area of the rear vertical side part 96 in the corner part 92, which is close to the upper side part 94 of the glass run 88, may be restrained with the outer side wall 106 of the upper side part 94, which is formed of a solid material identical to that of the trim section 104. However, the glass run 88 is provided with an area that is not retrained with the door frame 12 so that in the corner part 92 where the upper side part 94 that is to be assembled on a vehicle body in a widthwise direction thereof, is adjacent to the vertical side part 96 that is to be assembled on the vehicle body in a longitudinal direction thereof, an upper end of the vertical side part, which exhibits a great movable amount, may be assembled on the vertical side 146 of the door frame 12, whereby the vertical side of the corner part 92 of the glass run 88 is readily assembled.

It is preferable to form the exterior surface of the bottom wall 110 of the glass run section of the corner part 92 into an inclined and straight configuration. In this case, with the bottom wall 110 of the glass run section, which has an inclined and straight configuration, an area exhibiting a great movable amount can be provided in the neighborhood of the upper side 144, whereby the glass run 88 is readily assembled. As shown in FIG. 10, in the present embodiment, a gap between the bottom wall 110 of the glass run section and the corner 44 of the door frame 12 is filled with a corner piece 148. The corner piece 148 is formed in a substantially triangular shape so as to fill the gap in a joint of the upper side 144 and the vertical side 146 of the door frame 12.

Since the exterior surface of the bottom wall 110 of the corner part 92 is attached so as to be separated from a bottom surface of the channel 20, a fitting position of the bottom wall 110 of the corner part 92 in the corner 44 of the door frame 12 is located in a position slightly downwardly of the vehicle body, whereby the glass run 88 is readily assembled.

The assembling state of the corner part 92 of the glass run 88 will be explained with reference to FIGS. 8, 11 and 12.

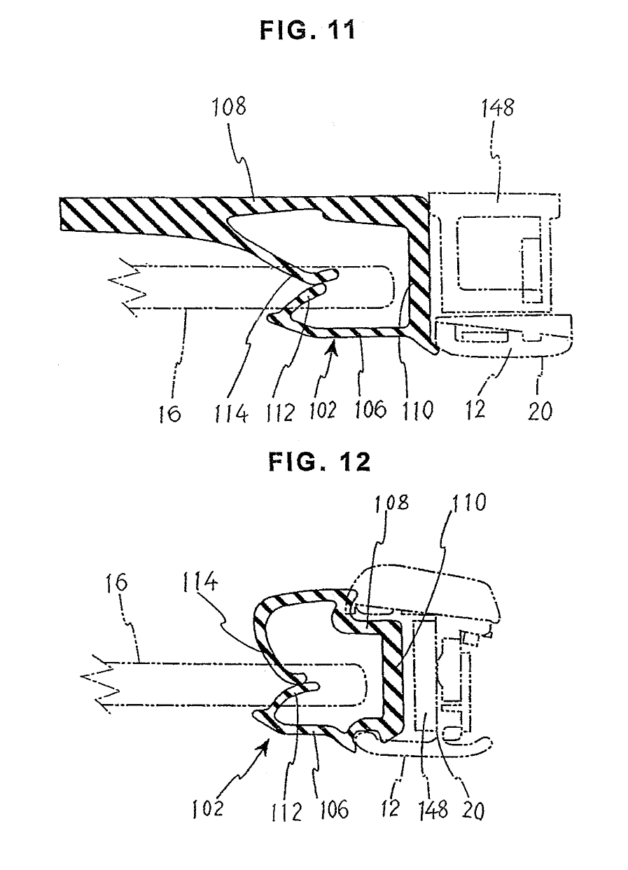

FIG. 8 illustrates the corner part 92 of the glass run 88, FIGS. 11 and 12 are respectively sectional views taken along line A-A and line B-B in FIG. 8.

As shown in FIG. 11, the bottom wall 110 of the glass run section in the corner part 92 is separated from the bottom of the channel 20 of the door frame 12 to contact the corner piece 148. In addition, as shown in FIG. 10, in the area of the corner part 12, which is taken along line B-B, the bottom wall 110 is separated from the bottom of the channel 20 of the door frame 1, and is fitted in only an entrance of the channel 20. Consequently, when the glass run 88 is fitted in the channel 20, the deformation amount of the glass run 88 can be reduced, thereby facilitating the insertion of the corner part 92 of the glass run 88 in the channel 20.

Upon forming the glass run 88, a synthetic rubber, a thermoplastic elastomer or a soft synthetic resin is used as the materials for the straight parts 90 and the corner parts 92. Examples of the synthetic rubber include an EPDM rubber, examples of the thermoplastic elastomer include an olefin elastomer, and examples of the soft synthetic resin include a soft vinyl chloride. Where the EPDM rubber and olefin elastomer are used, they are similar materials so that the glass run 88 can be readily recycled.

The straight parts 90 of the glass run 88 are formed into a linear shape by means of an extruder.

In the case of the synthetic rubber, after extrusion, it is transferred into a vulcanization chamber, and heated by hot wind and high frequency wave, etc. to be vulcanized. In the case of thermoplastic elastomer and soft synthetic resin, a cooling process is performed for solidification. Then, after vulcanization or solidification, a cutting process is performed into predetermined lengths. As a result, extruded parts are obtained.

The molded parts adapted to form the corner parts 92 of the glass run 88 are formed by cutting the extruded members adapted to form the straight parts 90 to predetermined dimensions, holding ends of the extruded members thus cut with a mold adapted to mold the molded parts, and injecting a molding material adapted to form the molded parts into a cavity of the mold. The cross-sectional shape of the molded part is approximately identical to that of the extruded part. It is preferable to use the molding material of the same kind with that of the material used to form the extruded part. In the case of the thermoplastic elastomer and the soft synthetic resin, the molding material injected into the mold is in the molten state, the extruded part and the molded part are integrally fused to each other with heat and pressure of the molding material.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A glass run for an automobile, which is adapted to be attached to an inner periphery of a door frame of a door of an automobile for guiding a door glass as it is raised and lowered, comprising:
straight parts formed by extrusion, and corner parts formed by molding for contacting corner pieces attached to corners of the door frame, said straight parts including an upper side part for attachment to an upper side of the door frame, a front vertical side part for attachment to a front vertical side of the door frame and a rear vertical side part for attachment to a rear vertical side of the door frame, wherein
said upper side part integrally includes a glass run section and a trim section composed of a hard material, and said glass run section has an outer side wall, an inner side wall and a bottom wall defining a generally U-shaped cross-section such that an outer seal lip and an inner seal lip respectively extend from ends of said outer side wall and said inner side wall obliquely inwardly to seal an exterior surface and an interior surface of an end edge of the door glass,
one of said front vertical side part and said rear vertical side part has an outer side wall, an inner side wall and a bottom wall defining a generally U-shaped cross-section such that an outer seal lip extends from an end of said outer side wall obliquely inwardly, and an inner seal lip extends from an end of said inner side wall obliquely inwardly, and
in said corner part connecting said upper side part to one of said front vertical side part and said rear vertical side part, said outer side wall, said inner side wall, said bottom wall, said outer seal lip and said inner seal lip are connected to corresponding parts of said upper side part and said vertical side part by molding into one of an inclined configuration and a curved configuration, and an exterior surface of said bottom wall of said glass run section is arranged such that an intersection point of an extension line of an end line of one of said front vertical side and said rear vertical side of said door frame, which is on the side of the door glass, and said trim section of said upper side part of said glass run is located on an outer peripheral side of said exterior surface of said bottom wall of said glass run section of said upper side part of said glass run.

2. The glass run as claimed in claim 1, wherein said exterior surface of said bottom wall of said glass run section of said corner part is formed into an oblique and straight configuration.

3. The glass run as claimed in claim 1, wherein said exterior surface of said bottom wall of said glass run section of said corner part is attached so as to be separated from a bottom of a channel provided in the corner of the door frame.
